(19) United States
(12) Patent Application Publication
(10) Pub. No.: US 2026/0167120 A1
(43) Pub. Date: Jun. 18, 2026

(54) SENSOR ASSEMBLY FOR A VEHICLE

(71) Applicant: AUMOVIO Autonomous Mobility Germany GmbH, Ingolstadt (DE)

(72) Inventors: Stefan Hegemann, Wangen im Allgäu (DE); Florian Geis, Geisenheim (DE)

(73) Assignee: AUMOVIO Autonomous Mobility Germany GmbH, Ingolstadt (DE)

(21) Appl. No.: 19/419,183

(22) Filed: Dec. 15, 2025

(30) Foreign Application Priority Data
Dec. 13, 2024 (DE) 10 2024 211 941.5

(51) Int. Cl. B60R 11/04; B60R 11/02

(52) U.S. Cl. CPC B60R 11/04; B60R 11/0264

(57) ABSTRACT

A sensor assembly for a vehicle comprises a sensor support and a cover, wherein the sensor support comprises at least one first and at least one second mounting plate. The first and second mounting plates are designed for receiving sensor modules, and in such a way that cover panels are attachable on multiple sides. The sensor support also comprises stabilizing elements which are arranged between the first and the second mounting plate, wherein the sensor support is designed symmetrically along a horizontal central axis and an orientation of the sensor assembly with respect to a direction of travel of the vehicle and the positioning on the vehicle is definable via the attachment of the cover.

### TECHNICAL FIELD

A sensor assembly for a vehicle comprising a cover and a sensor support are disclosed.

### BACKGROUND

Special sensor assemblies such as sensor pods or sensor clusters, which are arranged at specific locations on a vehicle, are already known from the prior art. In this case, these sensor assemblies can be attached, for example, on the right or left side of a vehicle or, for example, centrally on the roof of a vehicle.

The previously known sensor assemblies have the disadvantage that they are specifically designed for the attachment location, for example, on the left of a vehicle, and are only suitable for the attachment location. Attachment to another side is not possible using the currently available sensor assemblies.

Therefore, it is an object to provide a sensor assembly which allows use at different positions on a vehicle in order to enable more efficient production of the corresponding sensor assembly.

### SUMMARY

Initial considerations were that the sensor assemblies or sensor pods would have to consist of parts separate from one another. For example, a cover, or also a beauty cover, is necessary, which encloses the sensor assembly and due to which it is apparent at which position on the vehicle, for example, on the left or right side, the sensor assembly is attachable. Furthermore, the sensor assembly has to comprise correspondingly modularly designed components, which allow assembly and attachment to the various vehicle sides.

A sensor assembly for a vehicle is accordingly proposed, wherein the sensor assembly comprises a sensor support and a cover, wherein the sensor support comprises at least a first and at least one second mounting plate, wherein the first and second mounting plates are designed for receiving sensor modules, wherein the first and second mounting plates are furthermore designed in such a way that cover panels are attachable on multiple sides, the sensor support furthermore comprises stabilizing elements, which are arranged between the first and the second mounting plate, wherein the sensor support is designed symmetrically along a horizontal central axis and an orientation of the sensor assembly with respect to a direction of travel of the vehicle and the positioning on the vehicle is definable via the attachment of the cover.

The sensor assembly here is for example a sensor pod or a sensor cluster, which is attachable to an outer side of a vehicle. In this case, the vehicle can be either a truck or an automobile or some other land vehicle, aircraft, or watercraft.

In this context, the term sensor support denotes the part of the sensor assembly which is arranged within the cover and which comprises the various modular component parts of the sensor assembly.

Both the cover panels and also the sensor modules and the stabilizing elements can be attached to the mounting plate. The first and the second mounting plate may be designed identically. In this way only one type of mounting plate has to be produced, and the mounting plates can be rotated, and correspondingly arranged in the sensor assembly, depending on the desired orientation of the sensor assembly. Here, the mounting plates also have mounting points which are provided for mounting the various elements and which are arranged on the mounting plate in such a way that they can be used for mounting independently of the orientation.

The term sensor module refers here to an element which can contain multiple individual sensors. In this case, the sensor module having the individual sensors is fastened to the mounting plates.

The cover sheets and also the cover are in this case designed in such a way that they have openings for the respective individual sensors in order to ensure correct functioning of the sensors and not to restrict or block the field of view of the respective sensors.

Here, the stabilization elements are arranged symmetrically, for example symmetrically with respect to a horizontal axis. Here, the stabilizing elements can for example connect the first and the second mounting plate in an X-shape. Multiple X-shaped arrangements can also be provided along the width of the sensor assembly in this case. Other geometrical shapes are also conceivable for the attachment of the stabilizing elements, which ensure a corresponding stability of the sensor assembly and are symmetrical with respect to a horizontal mirror axis.

In a design, the sensor modules are designed as sensor inserts, wherein the sensor inserts comprise receptacles for sensors. The receptacles for the sensors are adapted according to the sensor type.

Furthermore, the sensor inserts of the sensor support may be designed in such a way that, depending on the predefined orientation of the sensor assembly, the sensor inserts are correspondingly aligned in the direction of travel of the vehicle and/or at a particular pitch angle. Accordingly, the sensor inserts or the sensor modules are symmetrical along a horizontal axis in such a way that a rotation of the sensor module is possible and only the respective sensors are correspondingly arranged in the sensor module.

In a further design, the cover is attachable to the cover panels of the sensor support. In this case, the cover has a specific orientation which in turn defines on which side of a vehicle the applicable sensor assembly is attachable.

### BRIEF DESCRIPTION OF THE DRAWINGS

Further designs are the subject matter of the drawings. In the figures:

FIG. 1: shows a schematic representation of a sensor assembly according to a design;

FIG. 2: shows a schematic representation of a sensor support having sensor modules; and

FIG. 3: shows a further schematic representation of a sensor assembly according to a design.

### DETAILED DESCRIPTION

FIG. 1 shows a schematic representation of a sensor assembly according to a design. In the representation, (a) shows a top view of a sensor assembly 1 according to a design. The sensor assembly 1 is designed here such that it is attachable to a left vehicle side, proceeding from a direction of travel or direction of view of the driver. Accordingly, reference numeral 1h denotes a rear side of the sensor assembly 1 and 1v denotes a front side of the sensor assembly 1. Reference numeral 8 denotes a sensor constructed on the sensor assembly 1.

The representation (b) shows a lateral representation of the sensor assembly 1 in a sectional representation. In this case, a first 3a and a second cover 3b are shown, which are respectively arranged above the first 2a and the second mounting plate 2b. The cover or the beauty cover can also be formed in one piece and completely encloses the sensor support 5. Stabilizing elements 4 are arranged between the mounting plates 2a and 2b. In this representation (b), the stabilizing elements 4 are arranged in the shape of a cross between the mounting plates 2a and 2b.

The representation (c) shows a top view of a mounting plate 2a, 2b. The mounting plate 2a, 2b is designed such that it can be used both for a sensor assembly 1 arranged on the left side of the vehicle and for a sensor assembly 1 arranged on the right side of the vehicle. In this case, the mounting plate 2a, 2b has multiple mounting points P which are distributed over the entire surface of the mounting plate 2a, 2b and can be used for mounting the sensor modules 5, the cover panels, and the stabilizing elements 4. Here, the mounting points P are arranged in such a way that they can be used equally independently of the rotation of the mounting plate 2a, 2b and independently of the rotation of the sensor modules 5.

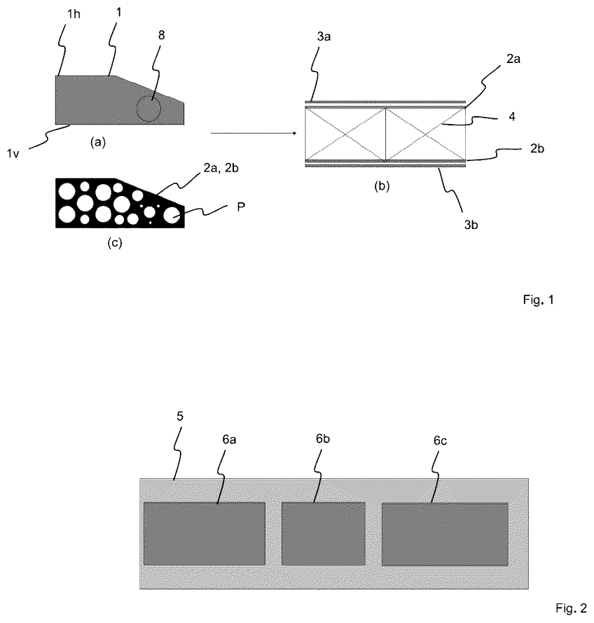

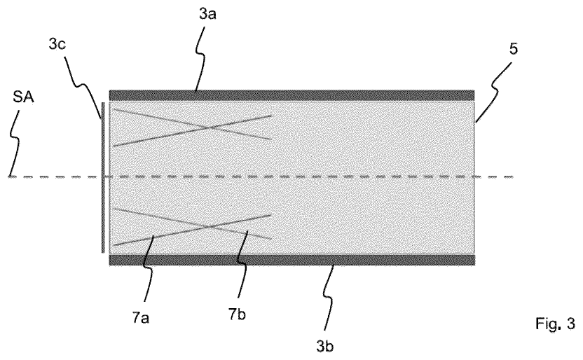

FIG. 2 shows a schematic representation of a sensor support having sensor modules. In this representation, the sensor support 5 shown here comprises multiple sensor modules 6a, 6b, and 6c. These sensor modules 6a, 6b, 6c are designed, for example, as sensor inserts and are configured to receive at least one sensor, e.g., a camera, a radar sensor, or a lidar sensor. The sensor modules 6a, 6b, 6c are mounted on at least one mounting plate 2a, 2b.

FIG. 3 shows a further schematic representation of a sensor assembly according to a design. In this representation, for example a horizontal mirror axis SA is shown. The sensor modules 6a, 6b, 6c, the sensor support 5, and the stabilizing elements 4 may be designed symmetrically with respect to such a horizontal mirror axis SA. Furthermore, multiple elements of the cover 3a, 3b, 3c which enclose the sensor support 5 are shown here. Furthermore, cable connections 7a, 7b are shown which connect the sensors in the sensor modules to one another and to an ECU of the vehicle. From the wiring, it is also apparent how the orientation of the sensor assembly will turn out, depending on the direction in which the individual cable connections converge.

1. A sensor assembly for a vehicle, wherein the sensor assembly comprising:
a cover having cover panels; and
a sensor support;
at least one first second mounting plate;
at least one second mounting plate, wherein the first and second mounting plates are designed for receiving sensor modules and wherein the cover panels are attachable on multiple sides of the first and second mounting plates; and
stabilizing elements which are arranged between the first and the second mounting plate;
wherein the sensor support is designed symmetrically along a horizontal central axis and an orientation of the sensor assembly with respect to a direction of travel of the vehicle and the positioning on the vehicle is definable via the attachment of the cover.

2. The sensor assembly as claimed in claim 1, wherein the sensor modules are sensor inserts, wherein the sensor inserts comprise receptacles for sensors.

3. The sensor assembly as claimed in claim 2, wherein the sensor inserts of the sensor support are designed in such a way that, depending on the predefined orientation of the sensor assembly, the sensor inserts are correspondingly aligned in at least one of the direction of travel of the vehicle and at a particular pitch angle.

4. The sensor assembly as claimed in claim 1, wherein the cover is attachable to the cover panels of the sensor support.
